(19) United States
(12) Patent Application Publication
(10) Pub. No.: US 2004/0248596 A1
(43) Pub. Date: Dec. 9, 2004

(54) Text message processing

(76) Inventor: Jignesh S. Panchal, Scotch Plains, NJ (US)

Correspondence Address: HARNESS, DICKEY & PIERCE, P.L.C., P.O. Box 8910, Reston, VA, 20195, US

(21) Appl. No.: 10/453,782

(22) Filed: Jun. 4, 2003

(51) Int. Cl. H04Q 7/20

(52) U.S. Cl. 455/466; 455/414.1

(57) ABSTRACT

Methods of scheduling, broadcasting and/or receiving one or more broadcast short text messages, constructing and/or scheduling one or more broadcast general page messages, preparing and/or scheduling one or more broadcast text messages, updating a broadcast slot cycle index, and/or a broadcast message queue for storing text messages.

### BACKGROUND OF THE INVENTION

Broadcast short text messages (B-STMs), also known as broadcast short message service (B-SMS) messages have become more popular because of the additional capability they offer mobile users, such as cellular telephone or personal digital assistant (PDA) users and the additional revenue they can produce for service providers. B-STMs or B-SMSs may be single events or periodic events and may contain information on one or more of weather, traffic, emergencies, sports, news, stock quotes, and advertisements. B-STMs or B-SMSs may also be used to broadcast messages to mobile users within a defined geographical area. B-STMs or B-SMSs often require the same resources used by other voice and/or data communication systems.

### SUMMARY OF THE INVENTION

Exemplary embodiments of the present invention are directed to methods of scheduling, broadcasting and/or receiving one or more broadcast short text messages. Other exemplary embodiments of the present invention are directed to methods of constructing and/or scheduling one or more broadcast general page messages, preparing and/or scheduling one or more broadcast text messages, and updating a broadcast slot cycle index. Other exemplary embodiments of the present invention are directed to a broadcast message queue for storing text messages.

### BRIEF DESCRIPTION OF THE DRAWINGS

Exemplary embodiments of the present invention will become more fully understood from the detailed description given below and the accompanying drawings, which are given for purposes of illustration only, and thus do not limit the invention.

FIG. 1 illustrates a wireless network architecture in accordance with an exemplary embodiment of the present invention.

FIG. 2 is a flowchart illustrating a method for constructing one or more B-GPMs in accordance with an exemplary embodiment of the present invention.

FIG. 3 illustrates a broadcast address of a text message, including exemplary parameters and bit lengths in accordance with an exemplary embodiment of the present invention.

FIG. 4 is a flowchart illustrating a method for scheduling one or more B-GPMs in accordance with an exemplary embodiment of the present invention.

FIG. 5 is a flowchart illustrating a method for preparing one or more B-STMs in accordance with an exemplary embodiment of the present invention.

FIG. 6 is a flowchart illustrating a method for scheduling one or more B-STMs in accordance with an exemplary embodiment of the present invention.

FIG. 7 is illustrates a pictorial view of the process of scheduling one or more B-STMs over a paging channel in accordance with an exemplary embodiment of the present invention.

FIG. 8 is a flowchart illustrating a method for updating a broadcast slot cycle index in accordance with an exemplary embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION OF THE EXEMPLARY EMBODIMENTS

In a general sense, exemplary embodiments of the present invention may be directed a design or one or more parts of a design to schedule, deliver, and/or receive text messages, such as B-STMs or B-SMSs. Exemplary embodiments of the design or parts of the design may be implemented in hardware, software, or a combination of both. Exemplary embodiments of the design or parts of the design may be implemented in a code division multiple access (CDMA) system, including a CDMA base station and one or more CDMA mobiles. Exemplary embodiments of the design or parts of the design may also be implemented in other wireless infrastructures, such as UMTS, GSM, or CDMA2000, as well as other wireless systems, such as a wireless local area network (LAN). Exemplary embodiments of the design or parts of the design may utilize one or more broadcast methods, such as a periodic broadcast method or a multicast method, utilized by the exemplary wireless systems.

An exemplary periodic broadcast method that may be used in exemplary embodiments of the present invention, is the periodic broadcast method utilized in CDMA2000 systems, as defined in the IS-2000 standard. This periodic broadcast method indicates that a broadcast slot cycle may run on a paging channel in parallel with a paging slot cycle. The broadcast slot cycle may use paging channel resources the same way as the paging slot cycle. The broadcast slots and paging slots may overlap each other, but their slot numbers are different. The broadcast slot cycle length may be calculated as follows:

broadcast_slot_cycle_length=(16×2ⁱ)+3.

where, i=BCAST_SLOT_CYCLE_INDEX and i⊂[1,2, . . . , 7].

The following formula may be used to find the current broadcast slot number in a given broadcast slot cycle.

$$broadcast\_slot \_number = ⌊ \frac{t}{4} ⌋ mod ( broadcast\_slot \_cycle \_length )$$

where t is the CDMA system time in frames. The first slot of the broadcast slot cycle is usually the broadcast_slot_number=0.

In accordance with the periodic broadcast method described in the IS-2000 standard a broadcast general page message (B-GPM) may be sent in the first slot of a broadcast slot cycle (i.e. broadcast_slot_number=0). Each B-GPM may be associated with a subsequent broadcast slot. For each record in the B-GPMs, an associated broadcast message may be transmitted in the (j×3) broadcast slot, where j is an index of a broadcast message. For example, broadcast message 1 may be sent on broadcast slot 3, broadcast message 2 may be sent on broadcast slot 6, etc.

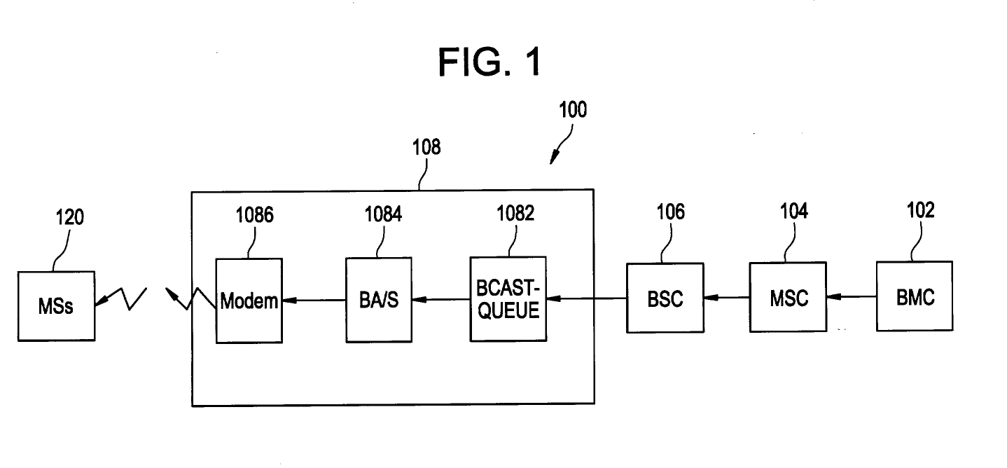

Exemplary embodiments of the design or parts of the design may also utilize one or more channels, such as a paging channel, provided by the exemplary wireless systems. The exemplary embodiment of the present invention discussed in conjunction with FIG. 1 below is described in the context of a CDMA2000 system, the periodic broadcast method described in the IS-2000 standard, and a paging channel, although, as describe above, these could be varied, as would be known to one of ordinary skill in the art.

FIG. 1 illustrates a wireless network architecture in accordance with an exemplary embodiment of the present invention. The wireless network architecture 100 may include a broadcast message center (BMC) 102, a mobile switching center (MSC) 104, a base station controller (BSC) 106, a base station transreceiver (BST) 108, and one or more mobile stations (MSs) 120.

A B-STM originated at BMC 102 may be received by BST 108 via MSC 104 and BSC 106. The BST 108 may store the received B-STM in a queue, for example, BCAST_QUEUE 1082. In an exemplary embodiment, after each broadcast slot cycle, messages in BCAST_QUEUE 1082 may be rearranged such that higher priority messages are extracted first. In an exemplary embodiment, duplicate message may nt be permitted in the BCAST_QUEUE 1082.

The BST 108 may also include a Broadcast Agent and Scheduler (BA/S) 1084 to schedule and deliver the received B-STMs either directly or indirectly from the BMC 102. The BA/S 1084 may construct a B-GPM for each B-STM and may schedule the B-GPM or B-GPMs in a broadcast slot (for example, broadcast slot 0) of a broadcast slot cycle over a paging channel.

Based on the received B-GPMs on the broadcast slot, one or more MSs 120 can determine how many B-STMs are scheduled to arrive and in which slots. After sending the B-GPMs, the BA/S 1084 may schedule the broadcast messages in desired slots of the broadcast slot cycle (for example, for a CDMA2000 system, in accordance with the IS-2000 standard). Each message scheduled in a slot by the BA/S 1084 may be picked up by a modem 1086 or a modem task of the BST 108 and can be delivered in a given paging slot over a paging channel.

The tasks performed by the BA/S 1084 may include constructing one or more B-GPMs, scheduling one or more B-GPMs, preparing one or more B-STMs, scheduling one or more B-STMs, and/or updating a broadcast slot cycle index. Each of these tasks are described in more detail below.

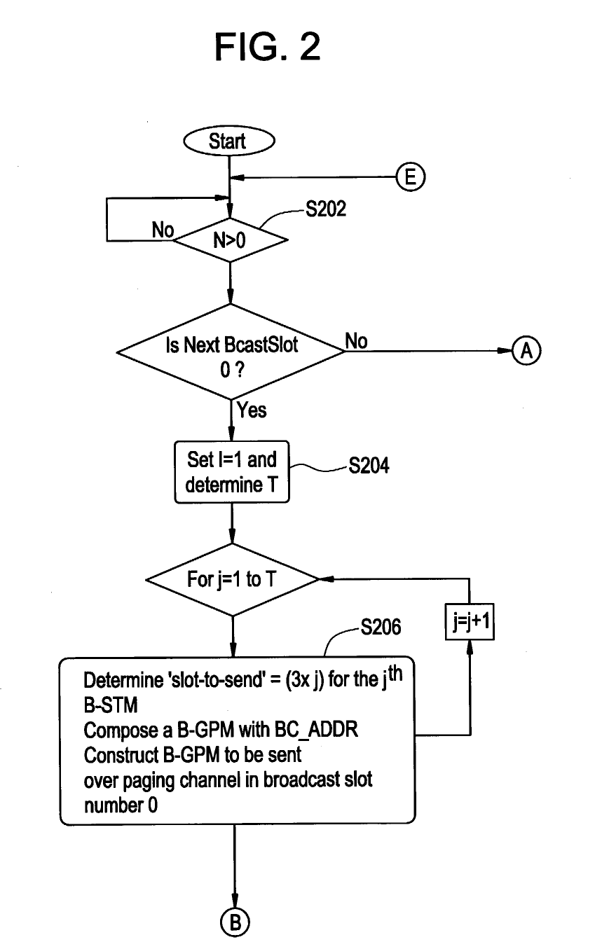

FIG. 2 is a flowchart illustrating a method for constructing one or more B-GPMs in accordance with an exemplary embodiment of the present invention. In order to construct one or more B-GPMs, the BA/S 1084 may determine one or more parameters, such as the number N of B-STMs in the BCAST_QUEUE 1082, a maximum number of B-STMs that can be sent in a next broadcast slot cycle, and a number T of candidate B-STMs that may be sent in the next broadcast slot cycle. If there are no B-STMs in the BCAST_QUEUE 1082 (at step S202, N<0), the BA/S 1084 need not perform any additional processing. If there are N>0 B-STMs in the BCAST_QUEUE 1082 then at step S204, T is determined. For example,

```
If (N > maximum_B-STM_per_broadcast_cycle)
  T = maximum_BSTM_per_broadcast_cycle
Else
  T = N.
```

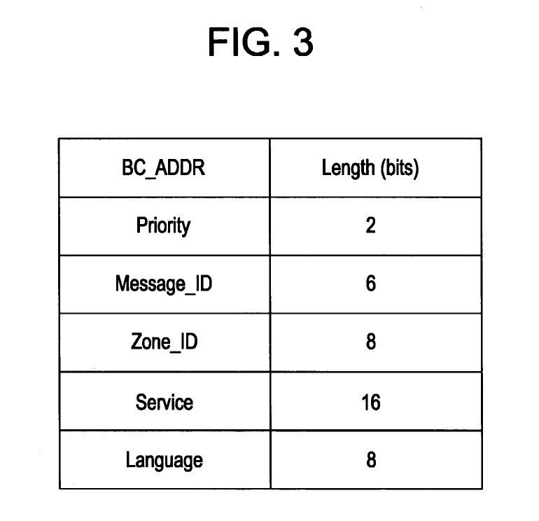

At this point, the BS/A 108 is aware that T B-STMs may be scheduled to be sent over the paging channel. The BS/A 108 may examine the first T stored B-STMs in the BCAST_QUEUE 108 and may extract their corresponding broadcast addresses (BC_ADDR). The BC_ADDR of a B-STM may contain one or more parameters, such as, Priority, Message_ID, Zone_ID, service, or language as illustrated in FIG. 3. The exemplary list of parameters and lengths in bits shown in FIG. 3 are the ones utilized in the IS-2000 standard.

The extracted BC_ADDRs of each B-STMs (for example, a total of T B-STMs) may be used to construct records for their respective B-GPMs. As shown in step S206, the BA/S 1084 may assign a “slot-to-send” to the first T candidate B-STMs. In an exemplary embodiment and as described above, the “slot-to-send” for the first B-STM may be broadcast slot number 3 because (j×3)=(1×3)=3. In general, the “slot-to-send” for the j^{th} B-STM may be broadcast slot number (j×3), where j=1,2, . . . , T.

Below is exemplary pseudocode and design flow for constructing one or more B-GPMs:

```
Construct B-GPMs: Just before Broadcast Slot Number = 0
{
  Determine T.
  For j=1 to T
  {
    Extract BC_ADDR as a record from the j^{th} B-STM
    Determine ‘slot-to-send’ = (3 x j) for the j^{th} B-STM
    Compose a B-GPM with the BC_ADDR,
    Prepare the j^{th} B-GPM to be sent over paging channel in broadcast
    slot 0.
  }
}
```

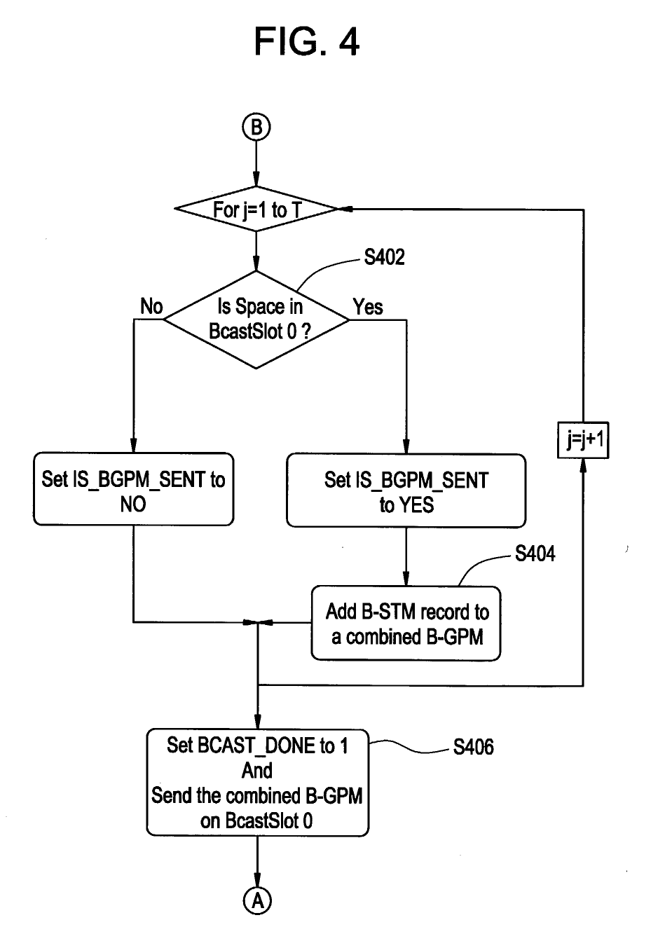

FIG. 4 is a flowchart illustrating a method for scheduling one or more B-GPMs in accordance with an exemplary embodiment of the present invention. The BA/S 1084 may schedule the constructed B-GPMs. Before scheduling, the BS/A 1084 may determine if all T B-GPMs can fit into the broadcast slot 0 or not. It may be that there is only enough space in the broadcast slot 0 to accommodate (T-X) B-GPMs. Hence, the remaining or last X B-GPMs of the total T may be dropped. Since the records for the X B-STMs could not be sent in their respective B-GPMs, the BA/S 1084 may mark the X B-STMs, for example, by setting a flag IS_BGPM_SENT to NO. This decision is shown in step S402 of FIG. 4. The X B-STMs may be rescheduled for delivery later.

The BA/S 1084 may combine the “to be delivered” (T-X) B-GPMs into a single B-GPM having (T-X) B-STM records. This is shown in step S404 of FIG. 4. The combined B-GPM may be delivered to a modem 1086 or modem task for sending over the paging channel in the broadcast slot number 0 (the first slot) of a broadcast slot cycle. This is shown in step S406 of FIG. 4.

After the combined B-GPM, there may not be any broadcast related messages scheduled. In this case, a flag, for example, a BCAST_DONE bit is set to 1 in the combined B-GPM. The BCAST_DONE bit set to 1 may signify that there will not be any broadcast related message coming in a given slot. Hence after receiving BCAST_DONE=1, each MS may go to sleep since there are no more broadcast related messages coming in a given slot. This is also shown in step S406 of FIG. 4.

Below is exemplary pseudocode and design flow for scheduling one or more B-GPMs:

```
Schedule B-GPMs in Broadcast Slot Number 0
{
  for each B-GPMs (total T B-GPMs)
  {
    if ( B-GPM is not scheduled because
      broadcast slot number 0 does not have space left)
    {
      Set IS_BGPM_SENT = NO
    }
    else
    {
      Set IS_BGPM_SENT = YES
      Add the B-STM record to the combine B-GPM.
    }
  }
  Set BCAST_DONE = 1 in the combined B-GPM.
  Deliver the combined B-GPM to modem 1086 or modem task to be sent
over the paging channel in broadcast slot number 0.
}
```

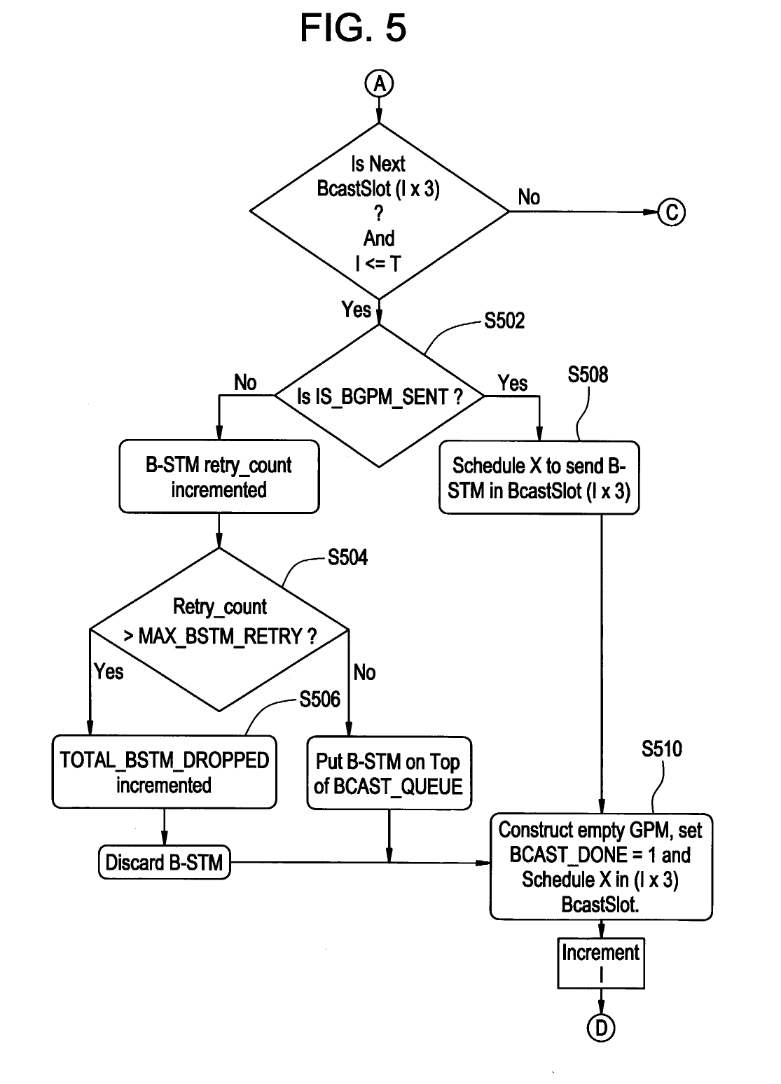

FIG. 5 is a flowchart illustrating a method for preparing one or more B-STMs in accordance with an exemplary embodiment of the present invention. The BA/S 1084 may use a global B-STM index I to track how many B-STMs have been scheduled thus far. If (I>T) then the BA/S 1084 may stop and not prepare any more B-STMs. I may be initialized to 1 in the broadcast slot 0 while constructing the B-GPMs and I=1,2, . . . , T.

If the BA/S 1084 is preparing an I^{th} B-STM to be delivered in the broadcast slot number (I×3), the BA/S 1084 may extract the I^{th} B-STM from BCAST_QUEUE 1082 and check if a B-GPM has been sent for the I^{th} B-STM or not. If a flag, for example, an IS_BGPM_SENT flag for the I^{th} B-STM is set to NO, the BA/S 1084 may increment a retry counter, called retry_count, for the I^{th} B-STM by 1. This decision is shown in step S502 of FIG. 5.

The BA/S 1084 may compare the retry counter with a threshold, for example, a MAX_BSTM_RETRY. If the B-STM retry counter is greater than the threshold, the B-STM may be discarded or dropped. Otherwise, the BA/S 1084 may place the B-STM back on top of the BCAST_QUEUE 1082. This decision is shown in step S504 of FIG. 5. If the B-STM is discarded or dropped, the BA/S 1084 may increment a global parameter, for example, a TOTAL_BSTM_DROPPED by 1. This is shown in step S506 of FIG. 5.

If the IS_BGPM_SENT flag for the I^{th} B-STM is set to YES, the BA/S 1084 may schedule the B-STM to be sent over the paging channel in the broadcast slot number (I×3). This is shown in step S508 of FIG. 5. After the I^{th} B-STM, there may not be any broadcast related messages scheduled, so an empty GPM (E-GPM) may be composed with a flag, for example, a BCAST_DONE bit set to 1. The E-GPM is called “empty” because it does not contain any records. This is shown in step S510 of FIG. 5. The E-GPM may also be scheduled to be delivered in the broadcast slot number (I×3) after the I^{th} B-STM. The E-GPM with the BCAST_DONE bit set in every (I×3) slot may be used to alert one or more mobiles 120 that no more B-STMs are coming in the remaining portion of the slot (I×3). With such information, the, one or more mobiles 120 may go back to sleep. The one or more mobiles may also wake up every (I×3) to receive an I^{th} B-STM. This arrangement may be used to save mobile battery power and extend the mobile battery life.

Below is exemplary pseudocode and design flow for preparing one or more B-STMs:

```
Prepare I^{th} B-STM : before Broadcast Slot Number (I x 3)
{
  De-queue the I^{th} B-STM of BCAST_QUEUE
  If (IS_BGPM_SENT == NO for the I^{th} B-STM)
  {
    I^{th} B-STM's retry_count is incremented (increment retry count by 1)
    if(retry_count >= MAX_BSTM_RETRY for the I^{th} B-STM)
    {
      TOTAL_BSTM_DROPPED is incremented
      Discard/Drop the I^{th} B-STM
    }
    else
    {
      Place the I^{th} B-STM back on top of BCAST_QUEUE.
    }
  }
  else If (IS_BGPM_SENT == YES for the I^{th} B-STM )
  {
    Schedule the i^{th} B-STM to be sent
    in broadcast slot number (I x 3).
  }
  Construct an E-GPM, set BCAST_DONE bit to 1, and
  Schedule E-GPM to be sent it in broadcast slot number (I x 3).
  I = I + 1 (increment global B-STM index by 1)
}
```

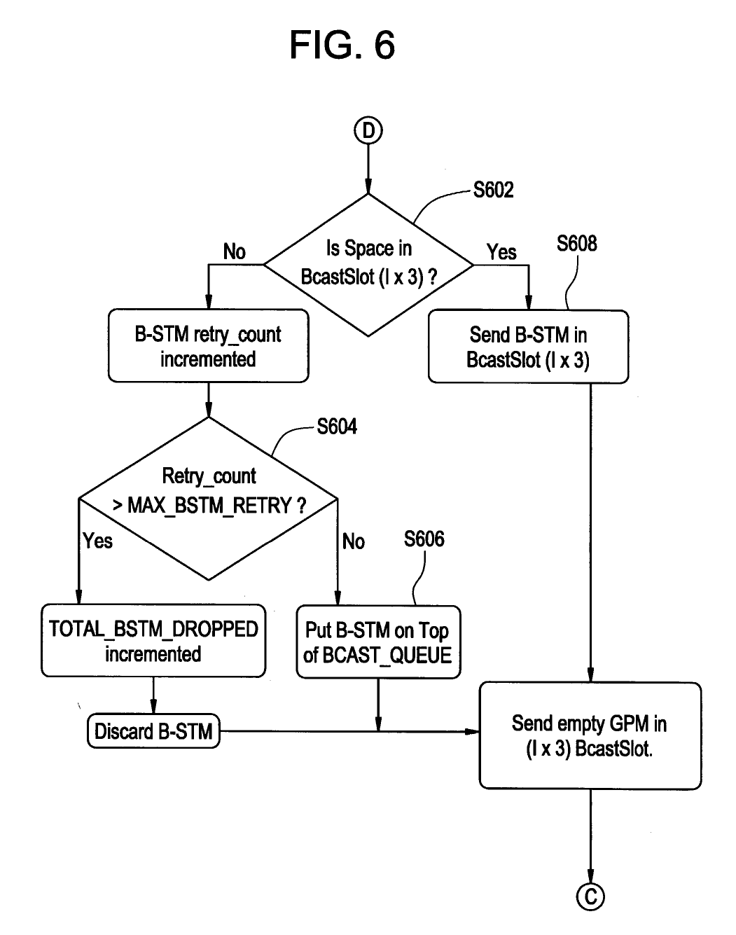

FIG. 6 is a flowchart illustrating a method for scheduling one or more B-STMs in accordance with an exemplary embodiment of the present invention. The BA/S 1084 may schedule the I^{th} B-STM to be sent over the paging channel in broadcast slot number (I×3). The BA/S 1084 may check if the I^{th} B-STM will fit in the in broadcast slot number (I×3). If there is not enough space in the slot to accommodate the I^{th} B-STM, the BA/S 1084 can recognize this as a failure to send the message. Hence, the BA/S may increment the retry_count of the I^{th} B-STM by 1 and reschedule the I^{th} B-STM for future delivery. This decision is shown in step S602 of FIG. 6.

The BA/S 1084 may again compare the I^{th} B-STM retry counter with the threshold MAX_BSTM_RETRY. This decision is shown in step S604 of FIG. 6. If the value of the B-STM retry counter is greater than the threshold, the B-STM may be discarded or dropped, otherwise the BA/S 1084 may place the I^{th} B-STM back on top of the BCAST_QUEUE 1082. If the B-STM is dropped, the BA/S 1084 may increment the global parameter TOTAL_BSTM_DROPPED by 1. This is shown in step S606 of FIG. 6.

If there is enough space to accommodate the I^{th} B-STM, the BA/S 1084 delivers the I^{th} B-STM to the modem 1086 or modem task to be sent in broadcast slot number (I×3). This is shown in step S608 of FIG. 6. Also, the BA/S 1084 may deliver the E-GPM with BCAST_DONE=1 to the modem 1086 or modem task to be sent in the same slot after the I^{th} B-STM. This is shown in step S610 of FIG. 6.

Below is exemplary pseudocode and design flow for scheduling one or more B-STMs:

```
Schedule B-STM: in broadcast slot number (I x 3)
{
  if(B-STM is not sent because slot ( I x 3)
    does not have space left)
  {
    I^{th} B-STM's retry_count incremented (increment retry count by 1)
    if(retry_count >= MAX_BSTM_RETRY for the I^{th} B-STM)
    {
      TOTAL_BSTM_DROPPED incremented
      Discard/Drop the I^{th} B-STM
    }
    else
    {
      Place the I^{th} B-STM back on top of BCAST_QUEUE.
    }
  }
  Else
  {
    Deliver the i^{th} B-STM to a modem or modem task to be sent over the
    paging channel in broadcast slot number (I x 3).
  }
  Deliver the E-GPM with BCAST_DONE = 1 to modem or modem
task to be sent in broadcast slot number (i x 3).
}
```

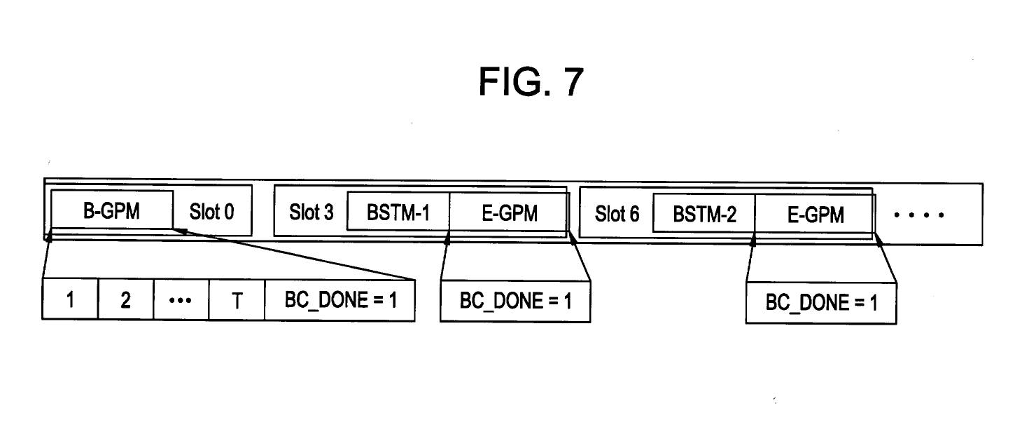

FIG. 7 is illustrates a pictorial view of the process of scheduling one or more B-STMs over a paging channel in accordance with an exemplary embodiment of the present invention.

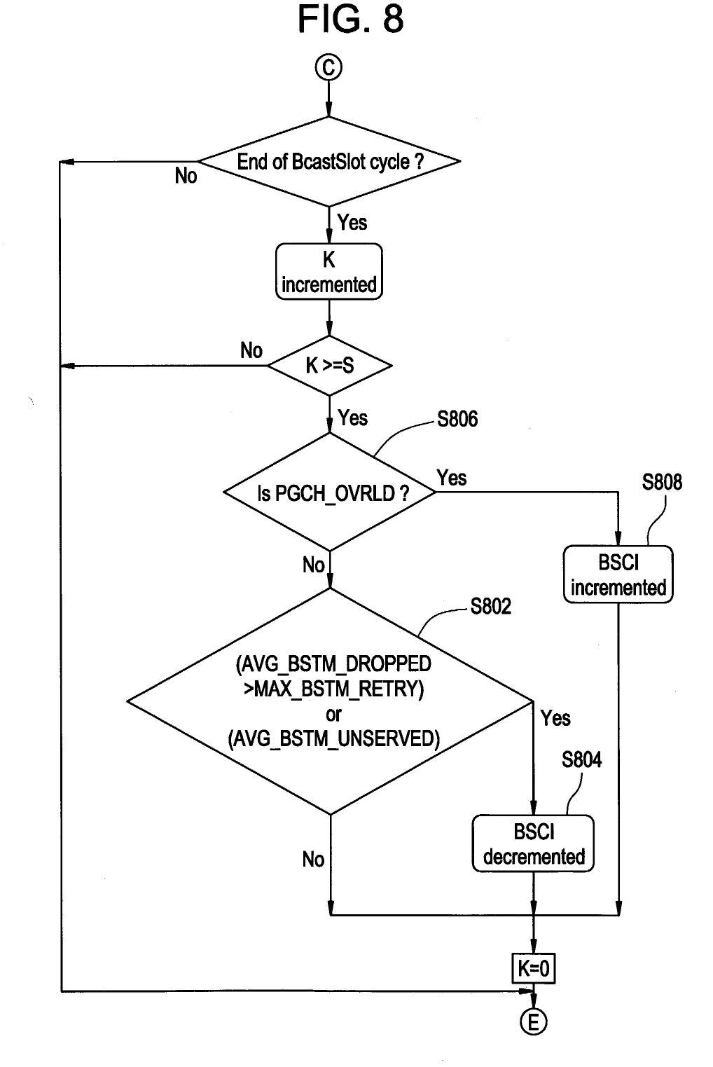

FIG. 8 is a flowchart illustrating a method for updating a broadcast slot cycle index (BSCI) in accordance with an exemplary embodiment of the present invention. By incrementing the BSCI, the length of a broadcast slot cycle may be increased such that on average, fewer B-GPMs can be sent. As a result, the frequency at which the BA/S 1084 schedules new B-STMs may decrease also. Similarly, decrementing the BSCI may decrease the length of the broadcast slot cycle. On average, more B-GPMs can be sent, hence B-STMs throughput over the paging channel may be increased.

If the average B-STM dropped count (AVG_BSTM_DROPPED) or the average number of unserved B-STMs (AVG_BSTM_UNSERVED) in BCAST_QUEUE 1082 at the end of a broadcast slot cycle is higher than one or more threshold values (for example in step S802 of FIG. 2), the BA/S 1084 may decrease the BSCI (for example, by 1) for the next broadcast slot cycle. In this manner, by decreasing the BSCI, the BA/S 1084 may increase the B-STMs throughput, hence reduce any B-STM backlog. This shown in step S804 of FIG. 8. The average number of unserved B-STMs (AVG_BSTM_DROPPED) may be derived from TOTAL_BSTM_DROPPED by sampling the value after every S broadcast slot cycles, where S is a tunable parameter.

In an exemplary embodiment, the value of S may be set to be 10, so after every 10 broadcast slot cycles, the BA/S 1084 may update the broadcast slot cycle index, if necessary. Similarly, the AVG_BSTM_UNSERVED may be derived by sampling the number of B-STMs in BCAST_QUEUE 1082 after every S broadcast slot cycles.

The threshold values of AVG_BSTM_DROPPED and AVG_BSTM_UNSERVED may be defined as MAX_BSTM_DROPPED and MAX_BSTM_UNSERVED and may also be tunable parameters.

In another example, when the paging channel is or may be in overload (i.e. PGCH_OVRLD flag is set), the BA/S 1084 may increase the index of the next broadcast slot cycle to reduce the load on paging channel due to B-STMs and B-GPMs. This is shown in steps S804 and S806 of FIG. 8, respectively.

The BSCI may be updated after every S broadcast slot cycles. The BA/S 1084 may track the number of broadcast slot cycles using, for example, a global variable K. The BA/S 1084 may increment K (for example, by 1) after every broadcast slot cycle.

Below is exemplary pseudocode and a design flow for updating a BSCI:

```
If (End of the Broadcast Slot Cycle)
{
  K++//Increment K
  If (K >= S)//After every S broadcast slot cycles
  {
    if(PGCH_OVRLD == YES)
    {
      BCAST_SLOT_CYCLE_INDEX incremented
    }
    else
    {
      if((AVG_BSMS_DROPPED > MAX_BSMS_DROPPED)
        or
      (AVG_BSMS_UNSERVED > MAX_BSMS_UNSERVED))
      {
        BCAST_SLOT_CYCLE_INDEX - -
      }
    }
    K = 0 //Reset K
  }
}
```

In exemplary embodiments of the present invention, text messages, such as B-SMSs or B-STMs can be used to broadcast messages to one or more mobile stations within a certain geographical area. Text messages, such as B-STMs or B-SMSs may be single events or periodic events and may contain information on one or more of weather, traffic, emergencies, sports, news, stock quotes, and advertisements.

One or more exemplary embodiments of the present invention have been described in conjunction with the network architecture shown in FIG. 1, however a subset of these elements could also be utilized as an alternative network architecture, as would be known to one ordinary skill in the art. Further, one or more exemplary embodiments of the present invention have been described as occurring at the BST 108 and more specifically, at the BA/S 1084, however one or more features could also be performed by other entities, as would also be known to one ordinary skill in the art.

The invention being thus described, it will be obvious that the same may be varied in many ways. Such variations are not to be regarded as departure from the spirit and scope of the exemplary embodiments of the present invention, and all such modifications are intended to be included within the scope of the following claims.

I claim:

1. A method of scheduling broadcast text messages comprising:
scheduling for transmission at least one constructed general page message for each of the broadcast text messages; and
scheduling each of the broadcast text messages for which the corresponding at least one general page message was transmitted.

2. The method of claim 1, said scheduling for transmission at least one constructed general page message step comprises:
identifying a number of the broadcast text messages to be sent;
identifying a number of slots in the wireless communications channel assigned to broadcast text messages; and
prioritizing the broadcast text messages.

3. The method of claim 1, said scheduling for transmission at least one constructed general page message step comprises storing the at least one general page message including at least one record in a queue.

4. The method of claim 3, wherein said scheduling for transmission at least one constructed general page message step comprises keeping track of which general page messages are constructed and scheduled, but not transmitted.

5. The method of claim 1, wherein at least one general page message may not be transmitted, due to transmission of other, higher priority services.

6. The method of claim 5, wherein the other, higher priority services comprises at least one of voice, data, and paging services.

7. The method of claim 1, wherein at least one general page message may not be transmitted, due to transmission of other, higher priority broadcast text messages.

8. The method of claim 7, wherein the higher priority broadcast text messages comprise at least one emergency broadcast text message.

9. The method of claim 1, wherein said step of scheduling the at least one general page message comprises scheduling as many general page messages as possible for a given slot cycle.

10. The method of claim 9, wherein said step of scheduling as many general page messages as possible for a given slot cycle comprises increasing or decreasing a broadcast slot cycle index.

11. The method of claim 5, wherein said step of scheduling the at least one general page message further comprises rescheduling any of the at least one general page message not transmitted, in a subsequent slot cycle.

12. The method of claim 1, wherein said step of scheduling each of the broadcast text messages is performed for each of the at least one general page messages that were transmitted.

13. The method of claim 1, wherein said step of scheduling each of the broadcast text messages comprises storing the each of the broadcast text messages in a queue.

14. The method of claim 13, wherein said step of scheduling each of the broadcast text messages comprises keeping track of which broadcast text messages are prepared and scheduled, but not transmitted.

15. The method of claim 14, wherein said step of scheduling each of the broadcast text messages comprises rescheduling any of the broadcast text messages not transmitted, in a subsequent slot cycle.

16. The method of claim 1, wherein the wireless communications channel is a paging channel and the at least one general page message and the broadcast text messages are sent in slots of the paging channel.

17. The method of claim 1, wherein the method is performed in a wireless communications system comprising at least one of an IS-2000, UMTS, and GSM wireless communications system.

18. The method of claim 17, wherein the method is performed by a base station of the wireless communications system.

19. The method of claim 18, wherein the method is performed by a broadcast schedule and agent of the base station.

21. A network entity in a communication system, comprising:
a broadcast message queue having a memory for storing a plurality of broadcast text messages of differing priorities;
wherein the plurality of broadcast text messages are stored in said memory in priority order and higher priority broadcast text messages are sent first in a given broadcast clock cycle;
wherein remaining broadcast text messages of the plurality of broadcast text messages are reprioritized in said memory so that remaining higher priority broadcast text messages are sent first in a subsequent broadcast clock cycle.

22. The network entity of claim 21, wherein said network entity is a base station.

23. A method of constructing broadcast general page messages, comprising:
identifying a number of broadcast text messages in a broadcast message queue for transmission in a broadcast slot cycle using a broadcast slot cycle index; and
constructing a broadcast general page message for each of the broadcast text messages in a broadcast message queue, the broadcast general page messages comprising a record for each of the number of broadcast general page messages in the broadcast message queue.

24. The method of claim 23, wherein each broadcast general page message contains a record corresponding to one broadcast text message.

25. The method of claim 23, wherein at least one broadcast general page message includes more than one record.

26. The method of claim 23, further comprising:
scheduling and sending the number of broadcast general page messages in a given slot of the broadcast slot cycle;
wherein if any of the number of broadcast general page messages cannot be sent because the given slot of the broadcast slot cycle is full, a flag is set for each of the number of broadcast general page messages containing records of corresponding broadcast text messages stored in the broadcast message queue and a broadcast general page message corresponding to each of the number of broadcast text messages that cannot be sent is dropped.

27. The method of claim 23, further comprising:
preparing the number of broadcast text messages from the broadcast message queue, comprising
preparing a first of the number of broadcast text messages to be sent out in a in a given slot of a broadcast slot cycle,
if a flag, which indicates that the broadcast general page message is sent or not, is set for the first of the number of broadcast text messages, incrementing a retry counter,
if the retry counter for the first of the number of broadcast text messages exceeds a threshold, removing the first of the number of broadcast text messages from the broadcast message queue and incrementing a drop counter,
sending the first of the number of broadcast text messages if there is space in the given slot of a broadcast slot cycle,
if there is no space, incrementing the retry counter,
if the retry counter for the first of the number of broadcast text messages exceeds the threshold, removing the first of the number of broadcast text messages from the broadcast message queue and incrementing the drop counter,
if the first of the number of broadcast text messages from the broadcast message queue is not dropped, sending the first of the number of broadcast text messages over a paging channel,
if a next of the number broadcast text messages is not a last messages, repeat the above steps, and
if a next of the number broadcast text messages is the last message, constructing an empty general page message with broadcast-done bit set and sending the empty general page message over the paging channel.

28. The method of claim 23, further comprising:
updating a broadcast slot cycle index, comprising
updating an average number of dropped broadcast text messages using a drop counter,
determining how many broadcast text messages remain in the broadcast message queue at the end of each broadcast slot cycle,
updating an average number of unserved broadcast text messages based on how many broadcast text messages remain in a broadcast message queue at the end of each broadcast slot cycle,
if the average number of dropped broadcast text messages or the average number of unserved broadcast text messages is higher than a threshold, decrementing the broadcast slot cycle index,
if the average number of dropped broadcast text messages or the average number of unserved broadcast text messages is lower than the threshold, incrementing the broadcast slot cycle index, and
if a paging channel is overloaded, incrementing the broadcast slot cycle index.
